(19) United States
(12) Patent Application Publication
(10) Pub. No.: US 2025/0053811 A1
(43) Pub. Date: Feb. 13, 2025

(54) SYSTEM AND METHOD FOR HARDWARE-AWARE PRUNING OF CONFORMER NETWORKS

(71) Applicant: Samsung Electronics Co., Ltd., Suwon-si (KR)

(72) Inventors: Ahmed ELKORDY, Los Angeles, CA (US); Behnam BABAGHOLAMI MOHAMADABADI, Escondido, CA (US); Mostafa EL-KHAMY, San Diego, CA (US)

(21) Appl. No.: 18/639,937

(22) Filed: Apr. 18, 2024

Related U.S. Application Data
(60) Provisional application No. 63/531,146, filed on Aug. 7, 2023.

(51) Int. Cl. G06N 3/082; G06N 3/04

(52) U.S. Cl. CPC G06N 3/082; G06N 3/04

(57) ABSTRACT

A system and a method are disclosed for hardware-aware pruning of conformer networks. In some embodiments, the method includes: training a neural network, the training including: performing a first pruning operation, on the neural network, after a first training epoch, and performing a second pruning operation, on the neural network, after a second training epoch and after the first pruning operation, wherein each of the pruning operations results in a respective pruning fraction, the respective pruning fraction being a function of an index of a training epoch preceding the pruning operation.

### CROSS-REFERENCE TO RELATED APPLICATION

This application claims the priority benefit under 35 U.S.C. § 119 (e) of U.S. Provisional Application No. 63/531,146, filed on Aug. 7, 2023, the disclosure of which is incorporated by reference in its entirety as if fully set forth herein.

### TECHNICAL FIELD

The disclosure generally relates to machine learning. More particularly, the subject matter disclosed herein relates to improvements to a reduced size machine learning model.

### SUMMARY

Human speech, when transmitted electronically (e.g., in a telephone call, or in a recording) may have various defects, such as noise and echo, which if mild may be distracting to the listener and if severe may prevent the listener from understanding some or all of the speech.

To solve this problem various methods for improving the quality of speech may be employed. Some such methods use neural networks, which may receive a digitally encoded audio signal corresponding to human speech and defects, and which may produce, from this signal, an improved signal in which the defects are absent or less severe.

One issue with the above approach is that such a neural network may be large, and costly to train, and that constructing a useful inference machine that performs inference based on the previously performed training may be less costly but nonetheless challenging in some processing systems, such as mobile devices, in which power and other resources may be limited.

To overcome these issues, systems and methods are described herein for reducing the size of a neural network. These methods may include pruning, parameter sharing, reducing the number of input channels, and knowledge distillation.

The above approaches improve on previous methods because their use may result in a significantly smaller neural network, which may be less costly to construct and operate, and which may be suitable for implementation in a mobile device.

According to an embodiment of the present disclosure, there is provided a method, including: training a neural network, the training including: performing a first pruning operation, on the neural network, after a first training epoch, and performing a second pruning operation, on the neural network, after a second training epoch and after the first pruning operation, wherein each of the pruning operations results in a respective pruning fraction, the respective pruning fraction being a function of an index of a training epoch preceding the pruning operation.

In some embodiments, an increase in a pruning fraction during the second pruning operation is less than an increase in the pruning fraction during the first pruning operation.

In some embodiments, the method further includes training the neural network in a third training epoch, after the first training epoch, and before the second training epoch.

In some embodiments, the method further includes performing a third pruning operation on the neural network after the second pruning operation, wherein an increase in the respective pruning fraction during the third pruning operation is less than an increase in the respective pruning fraction during the second pruning operation.

In some embodiments: the training includes performing a sequence of four or more pruning operations, each of the pruning operations of the sequence increases a respective pruning fraction by an amount less than a preceding pruning operation of the sequence, the sequence ends at a stopping epoch for pruning, and the stopping epoch for pruning is a training epoch after which a final pruning operation of the sequence is performed.

In some embodiments, each of the pruning operations results in a respective pruning fraction, the respective pruning fraction being a function of: an index of a training epoch, a number of training epochs per pruning operation, and an initial pruning fraction.

In some embodiments, the function has: a value of zero when the index of the training epoch is less than the number of training epochs per pruning operation, and a value of the initial pruning fraction, after the first pruning operation.

In some embodiments: for each training epoch less than or equal to the stopping epoch for pruning: the function includes a second term subtracted from a first term, the first term is one, the second term is a first difference raised to the power of the floor of the ratio of the index of the training epoch and the number of training epochs per pruning operation, and the first difference is one less the initial pruning fraction; and for each training epoch greater than the stopping epoch, the function is equal to the respective pruning fraction after the last pruning operation.

In some embodiments: the neural network includes a fully connected layer; and the first pruning operation includes removing a row or a column of the fully connected layer.

In some embodiments: the neural network includes a multi-head self-attention block; and the first pruning operation includes removing a row or a column of the multi-head self-attention block.

In some embodiments: the neural network includes a convolutional layer; and the first pruning operation includes removing a row or a column or a channel of a convolutional kernel of the convolutional layer.

In some embodiments: the neural network includes a first conformer layer and a second conformer layer, and the training includes setting each of a plurality of weights of the second conformer layer equal to a respective weight of the first conformer layer.

In some embodiments, the training includes knowledge distillation.

In some embodiments, the method further includes receiving, by the neural network, a raw signal, and producing, by the neural network, an output, the output including an enhanced signal corresponding to the raw signal.

According to an embodiment of the present disclosure, there is provided a system including: one or more processors; and a memory storing instructions which, when executed by the one or more processors, cause performance of: training a neural network, the training including: performing a first pruning operation, on the neural network, after a first training epoch, and performing a second pruning operation, on the neural network, after a second training epoch and after the first pruning operation, wherein each of the pruning operations results in a respective pruning fraction, the respective pruning fraction being a function of an index of a training epoch preceding the pruning operation.

In some embodiments: the neural network includes a fully connected layer; and the first pruning operation includes removing a row or a column of the fully connected layer.

In some embodiments: the neural network includes a multi-head self-attention block; and the first pruning operation includes removing a row or a column of the multi-head self-attention block.

In some embodiments: the neural network includes a convolutional layer; and the first pruning operation includes removing a row or a column or a channel of a convolutional kernel of the convolutional layer.

In some embodiments: the neural network includes a first conformer layer and a second conformer layer, and the training includes setting each of a plurality of weights of the second conformer layer equal to a respective weight of the first conformer layer.

According to an embodiment of the present disclosure, there is provided a system including: means for processing; and a memory storing instructions which, when executed by the means for processing, cause performance of: training a neural network, the training including: performing a first pruning operation, on the neural network, after a first training epoch, and performing a second pruning operation, on the neural network, after a second training epoch and after the first pruning operation, wherein each of the pruning operations results in a respective pruning fraction, the respective pruning fraction being a function of an index of a training epoch preceding the pruning operation.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a system for processing speech, according to an embodiment.

FIG. 2 is a graph of pruning fraction as a function of training epoch, according to an embodiment.

FIG. 3 is a flowchart of a method, according to an embodiment.

FIG. 4 is a block diagram of an electronic device in a network environment, according to an embodiment.

FIG. 5 shows a system including a UE and a gNB in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Speech enhancement using machine learning has emerged as a pivotal research area in recent years, driven by the fundamental importance of clear and intelligible communication, between a speaker and a listener, in various real-world applications. Effective human communication is often impeded by environmental interferences, such as background noise, reverberation, and other distortions, leading to degraded speech quality. The motivation behind speech enhancement lies in the quest to overcome these challenges and enhance the overall quality of speech signals for improved human-computer interaction, speech recognition systems, telecommunication, hearing aids, and other speech-related applications. Deep learning may be used to enhance the quality of speech, leading to significant advances, and providing promising solutions that hold the potential to reshape the landscape of speech communication in a multitude of domains.

As mentioned above, neural networks for speech enhancement may be relatively large. For example, a machine language model (e.g., a neural network) for speech processing may have a large memory footprint, and a large parameter count with over 1.8 million parameters, and may require significant computation resources to process one training example (with, for example, a multiplication and accumulation count (MAC count) of greater than 16 billion). It may be challenging to deploy such a neural network in resource-constrained edge devices.

As such, some embodiments may achieve a memory reduction of more than 90%, and a reduction in the MAC count to approximately 2 billion. Further, in some embodiments, 90% of the performance of the original model may be retained. In some embodiments, this is accomplished by combining neural network pruning with three other compression techniques: parameter sharing, knowledge distillation, and input channel reduction.

In some embodiments, in which the MAC count is the bottleneck, parameter sharing (which primarily reduces the parameter count, without significantly decreasing the MAC count) may be omitted. A pruning scheduler may be used to adjust the rate of pruning at every epoch. In some embodiments, gradual pruning is performed early rather than doing aggressive pruning at the end of the training.

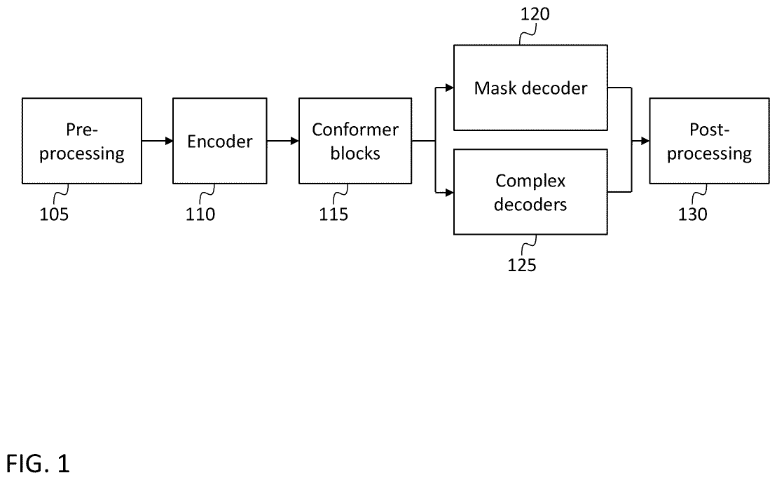

FIG. 1 is a block diagram of an example of a conformer-based metric generative adversarial network (CMGAN) which may be used for speech enhancement or for other signal processing tasks, as discussed in further detail below. The model architecture, in some embodiments, includes several blocks, including a pre-processing block 105, an encoder 110, one or more conformer blocks 115, a mask decoder 120, one or more complex decoders 125, and a post-processing block 130. The pre-processing block 105 may receive a digitized audio stream (e.g., a sequence of numbers, each being proportional to a respective sample of a voltage produced by a microphone), and (i) break the digitized audio stream into a plurality of short segments, (ii) calculate a short-time Fourier transform from each segment, and (iii) assemble the short-time Fourier transforms into a two-dimensional array. The encoder 110 may include a plurality of dilated densely connected convolutional layers (or “convolution layers”). For example, the encoder 110 may include two convolution blocks with a dilated plurality of densely connected convolutional layers between the two convolution blocks. Each convolution block may include a convolution layer, an instance normalization and a parametric rectified linear unit (PreLU) activation. The first convolution block may be used to extend the three input features to an intermediate feature map with C channels. Each of the dilated densely connected convolutional layers may contain four convolution blocks with dense connections, and the dilation factors of the four blocks may be set to 1, 2, 4, and 8, respectively. The dense connections may aggregate all previous feature maps to extract different features.

Each conformer block 115 may include a time conformer and frequency conformer. Each conformer block 115 may utilize two half step feed-forward neural networks (FFNNs). Between the two FFNNs, a multi-head self-attention (MHSA) block with four heads may be employed, followed by a convolution module. The convolution module may start with a layer normalization, a point-wise convolution layer and a gated linear unit (GLU) activation to diminish the vanishing gradient problem. The output of the GLU is then passed to a 1D-depth-wise convolution layer with a swish activation function, then another point-wise convolution layer. Finally, a dropout layer may be used to regularize the network. The mask decoder 120 and the complex decoders 125 may include a dilated plurality of densely connected convolutional layers, similar to the one in the encoder 110. A subpixel convolution layer may be utilized in both the path through the mask decoder 120 and the path through the complex decoders 125 to up-sample the frequency dimension back to the original sampling frequency. For the mask decoder 120, a convolution block may be used to reduce the channel number to 1, followed by another convolution layer with PRELU activation to predict the final mask. The post-processing block 130 may convert the outputs of the mask decoder 120 and of the complex decoders 125 into a digital audio stream containing the enhanced speech signal.

A method for using the neural network of FIG. 1 may include, for example, (i) feeding a raw (e.g., unenhanced) digitized audio stream to the pre-processing block 105 and (ii) receiving, from the post-processing block 130, an enhanced digital audio stream. The enhanced digital audio stream may then be converted (i) to an analog electrical signal and then (ii) to sound, by a suitable transducer (e.g., a loudspeaker in a mobile telephone or in an car bud worn by the listener). When used for speech enhancement, the neural network of FIG. 1 may be used, for example, to render speech more intelligible after the speech signal has been degraded by any of various mechanisms or circumstances. Degradation of the quality of the speech signal may occur, for example, if the speaker is using a microphone (i) that adds a significant amount of noise to the audio signal captured, or (ii) that distorts the audio signal, or (iii) that is omnidirectional (allowing it to capture undesired sound from directions other than the direction from the mouth of the speaker, and causing it to produce low gain for sound from the mouth of the speaker), or (iv) that is unidirectional (e.g., that has relatively high gain in one direction) and that is not properly aimed at the mouth of the speaker, or (v) that is affected by turbulence-related sound generated at the microphone by wind or by air exiting the mouth of the speaker as the speaker speaks, or (vi) that is affected by other vibrations produced, e.g., by rubbing of the clothing of the speaker (e.g., the speaker's sleeve) against the microphone, or the device containing the microphone, while the speaker speaks.

Other mechanisms by which the speech signal may be degraded include loss (e.g., from compression and decompression of the speech signal) during transmission through a channel (e.g., a mobile telephone network channel) to a device used by the listener, or noise or interference in the channel, which may, for example, result in occasional uncorrectable errors. In such a situation, the neural network of FIG. 1 may, for example, be implemented in a mobile telephone used by the listener, and the use of the neural network of FIG. 1 may make it possible for the listener to understand otherwise unintelligible speech, or to understand the received speech more easily than if the neural network were not used to enhance the speech signal. Other applications for speech enhancement include enhancing speech signal quality when the speech signal is a speech signal received by a hearing aid, or by a two-way radio, or by a loudspeaker of a public address (PA) system, or when the speech signal is a speech signal accompanying video content (e.g., a news broadcast, or a movie or television show, or independently produced content such as a video self-published on the internet). In any such application, enhancement of the speech signal (e.g., by the neural network of FIG. 1) may be performed at any suitable point in the transmission from speaker to listener at which the speech signal is in electronic (e.g., in digital) form and after degradation of the speech signal has occurred. For example, if the degradation occurs primarily at the microphone, the enhancement may be performed immediately after conversion of the analog signal from the microphone to a digital speech signal, or at any subsequent point in the signal chain. If the degradation occurs during subsequent transmission (e.g., over a WiFi connection between the microphone and a loudspeaker of a PA system) then the enhancement may be performed immediately after the degradation occurs, or at any subsequent point in the signal chain.

Other examples of applications for speech enhancement include enhancing speech signal quality when the speech signal is a speech signal received from an air traffic controller by a pilot, or by an air traffic controller from a pilot. Applications for the neural network of FIG. 1 outside the field of speech enhancement are discussed below.

Pruning of weights may include structured pruning and unstructured pruning. Unstructured pruning may have the following objective:

$$arg {min}_{{W}_{p}} L ( x ; {W}_{p} ) \qquad ( 1 )$$

$$subject to$$

$${‖ {W}_{p} ‖}_{0} < N$$

where Wₚ is a set of model parameters (e.g., weights), x is a set of training data, L is a loss function, and N is the number of non-zero parameters (e.g., weights). As used herein, “parameters” and “weights” are synonymous.

Neural network pruning may be broadly classified into two main categories, model pruning and ephemeral pruning. In model pruning, the pruning is performed on the model level. This includes weight pruning, neuron, channel, and filter pruning. Ephemeral pruning may be performed on the example level. For example, a ReLU activation may turn off some neurons if the input is less than zero. Another example of ephemeral pruning is dynamic routing of examples through different parts of the network.

Model pruning may be performed at different granularities. For example, in a fully connected layer pruning may be performed at two different granularities, which may be referred to as unstructured pruning and structured pruning. In unstructured pruning the weights to be removed may be selected in a flexible manner.

In structured pruning, pruning may be performed at the neuron level. In structured pruning, pruning may correspond to removing an entire row or column from a dense layer (e.g., from a fully connected layer or from a dense layer of a multi-head self-attention block). In case of a convolution layer, structured pruning may involve pruning a whole row or column of weights in the convolutional kernel, or it may involve removing a whole weight channel from the weight kernel, which may correspond to having a smaller output feature map size at the kernel output. Structured pruning may be less flexible than unstructured pruning, but it may be more readily implemented in hardware capable of producing significant performance improvements, and it may be suitable for producing significant performance improvements when hardware-aware pruning (pruning that is structured according to the hardware, e.g., according to the row and column structure of the neural network).

A two-dimensional (2-D) convolution layer may be parameterized by

$$W ∈ {R}^{{c}_{out} \times {c}_{in} \times w \times h} ,$$

where cₒᵤₜ, cᵢₙ, w and h are the number of filters (output channels), input channels, width and height of the layer respectively. These four different parameters may control the pruning granularities.

In some embodiments, channel pruning is employed, as the densely connected convolutional layers used in the encoder 110 and decoders may capture redundant information and therefore be good candidates for pruning.

Pruning techniques can be classified into different categories. In dense-to-sparse training, either (i) the model is trained until convergence and then pruned, or (ii) pruning is performed iteratively during the training process. Another category of pruning is sparse-to-sparse training, the use of which may be advantageous in settings in which reducing training cost is a crucial factor.

In some embodiments, iterative pruning is used. The following pruning scheduler may be used for each layer subjected to pruning.

$${p}_{e} = \{ \begin{matrix}1 - {( 1 - {p}_{0} )}^{⌊ \frac{e}{r} ⌋} & if e \leq s \\ no pruning & if e > s\end{matrix} \qquad ( 2 )$$

where pₑ is the pruning fraction at epoch e, p₀ is the initial pruning fraction, e is the index (e.g., the number) of the current training epoch, r is the number of training epochs per pruning operation, and s is the stopping epoch for pruning. As used herein, the “pruning fraction” at an epoch is the ratio of (i) the weights set to zero (or pruned) during the present epoch and all preceding epochs to (ii) the number of nonzero weights at the beginning of training.

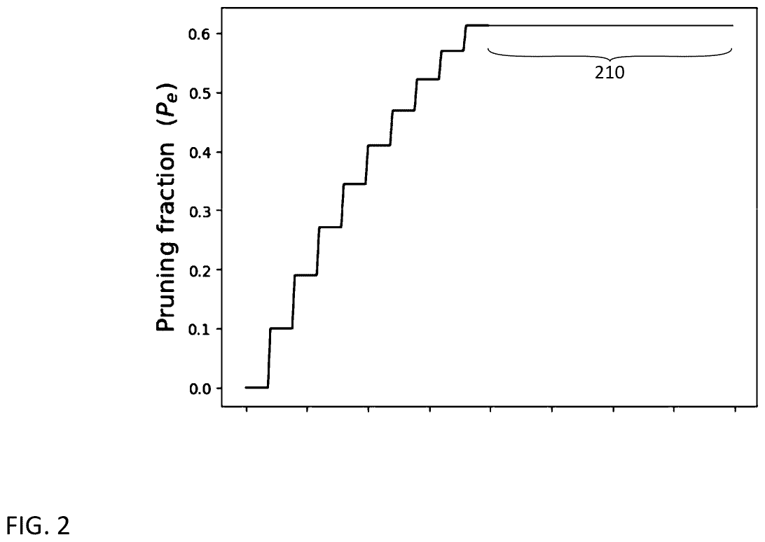

FIG. 2 shows an example for the pruning scheduler with p₀=0.1, r=10, and s=100. The design of this pruning scheduler has the following characteristics: (i) gradual pruning with reduced step is performed initially, where the number of pruned weights decreases as the training progresses, and (ii) fine-tuning of the model is performed after pruning (after s training epochs, during a fine-tuning stage 210) to recover some of the performance loss that may have been caused by pruning.

In some embodiments, magnitude weight pruning is employed. This pruning may result in a significant reduction in model size without significant loss of performance because a channel with a small L2 norm may result in a small activation value that contributes less to the output and, as such, may be pruned without significantly impacting the performance. The score for channels or layers may be calculated using the following two equations. For fully connected layers, the L2 norm for each input neuron may be computed as follows:

$${s}_{i}^{l} = \sqrt{{\sum }_{j ∈ {c}_{out}} {{W}^{l} ( i , j )}^{2}} ∀ i ∈ {c}_{in} \qquad ( 3 )$$

where s; is the score of input neuron i in layer l. The value of each weight W^{l}(cₒᵤₜ, i) of each of the pruned fully connected layers depends on the score and is given by

$${W}^{l} ( {c}_{out} , i ) = \{ \begin{matrix}0 & if {s}_{i}^{l} < t \\ {W}^{l} ( {c}_{out} , i ) & otherwise\end{matrix} \qquad ( 4 )$$

where t is the pruning threshold, which may be calculated (or adjusted empirically) to result in the specified pruning fraction pₑ.

The per channel score sᵢ^{l} for a convolution layer may be given by:

$${s}_{i}^{l} = \sqrt{{\sum }_{j ∈ {c}_{out}} {\sum }_{k ∈ w} {\sum }_{{k}^{′} ∈ h} {{W}^{l} ( j , k , {k}^{′} )}^{2}} ∀ i ∈ {c}_{in} \qquad ( 5 )$$

The pruned value of each weight of a fully connected layer may be given by

$${W}^{l} ( {c}_{out} , i , w , h ) = \{ \begin{matrix}0 & if {s}_{i}^{l} < t \\ {W}^{l} ( {c}_{out} , i , w , h ) & otherwise\end{matrix} \qquad ( 6 )$$

As mentioned above, a 2-D convolution layer may be parameterized by

$$W ∈ {R}^{{c}_{out} \times {c}_{in} \times w \times h} ,$$

where cₒᵤₜ, cᵢₙ, w and h are the number of filters (output channels), input channels, width and height of the layer respectively. In a 1-D convolution layer, a three-dimensional tensor, W∈R^{c}^{ₒᵤₜ}^{×c}^{ᵢₙ}^{×w} is processed. A fully connected layer can be parameterized by W E R^{c}^{ₒᵤₜ}^{×c}^{ᵢₙ}, where cₒᵤₜ, cᵢₙ, are the number of filters (output channels) and input channels respectively.

To summarize, pruning (e.g., structured pruning) may be performed as follows. For a fully connected layer i, with cᵢₙ>c₂, a fraction of the input neurons may be removed using Equation 4. Here c₁=c₂=c is a user-defined-threshold which specifies which layers need to be pruned. As such, the thresholds c₂ and c₁ (used below) define a predefined user threshold for the number of input channels cᵢₙ (if cᵢₙ is less than c₂ or c₁, the weights coming out of cᵢₙ are not pruned). This reduces the size of the layer, and the output channels of the preceding layer.

For a convolution layer with cᵢₙ>c₁ for arbitrary c₁, a fraction of channels (e.g., one or more of the channels) may be removed across all filters with the lowest score, as calculated using Equation 5. If the input to layer i is the output from layer i-1 and layer i-1 exclusively feeds layer i, then the corresponding filters in layer i may be removed. However, for the dilated densely connected convolutional layers in the encoder and decoders, in some embodiments, only the channels on the first layer are pruned, as the input to each layer is dilated.

In addition to pruning, several other methods may be used to reduce the computational resources used by the neural network. These include parameter sharing, input channel reduction, and knowledge distillation. In parameter sharing, the parameters (e.g., the weights) of the first conformer block 115 may be repeated (e.g., mirrored, or re-used) across all the remaining conformer blocks, e.g., the training of the neural network may include setting each of a plurality of weights of a second conformer layer equal to a respective weight of the first conformer layer. The use of parameter sharing may make it possible to save 30% in the total number of parameters.

Input channel reduction may involve, instead of scaling the number of channels of the input from 3 to c in the dense encoder block 110 where, for example, c=64 for the original model, a smaller number of channels may be used. For example, 12 hyper parameters may be used; these may be latent feature channels. Knowledge distillation, also known as teacher-student learning, may be used such that the compressed model, known as the student, learns from the pretrained original (full-size) model which may be known as the teacher. The knowledge of the trained teacher model may be transferred to the student by, for example, training the student with a loss function that includes the mean squared error (MSE) between the student's output and the teacher's output. More formally, the knowledge distillation loss used may given by the following equation:

$${L}_{KD} = \frac{1}{N} {‖ {Y}_{T} - {Y}_{S} ‖}^{2} + {‖ {X}_{T} - {X}_{S} ‖}^{2}$$

where N, Y and X are the output length, and the outputs from the mask decoder 120 and the complex decoder 125, respectively. The subscripts T and S stand for teacher and student respectively. Therefore, the combined loss function used in training the compressed model may be given by

$$L = {L}_{0} + λ {L}_{KD}$$

where L₀ is the original loss function and λ>0.

In some embodiments, a neural network constructed according to methods disclosed herein may be sufficiently small (e.g., it may consume sufficiently little power, and have sufficiently low computing resource requirements) to be executed on a User Equipment (UE), e.g., a mobile telephone, or on another mobile device (e.g., a tablet computer or a laptop).

As mentioned above, the neural network of FIG. 1, trained using methods described herein, or a different neural network trained using methods described herein may be used for speech enhancement or for other applications in which it may be advantageous to enhance the quality of a signal (e.g., of a signal that his not necessarily a speech signal or a sound signal). Such a signal may be, for example, a received wireless (e.g., cellular or WiFi or Bluetooth) data signal, or a received Global Positioning System signal. In other examples, signals that may be enhanced may be signals conveying information from one part of a system to another, e.g., a processing monitoring signal in a manufacturing plant (e.g., a signal that indicates a temperature, a pressure, or a flow rate at a point in a processing plant (e.g., in a semiconductor manufacturing plant or in a refinery) or a signal transmitted from one part of a vehicle to another (such as a tire pressure signal, an exhaust oxygen signal, a fuel level signal, or an outside air temperature signal). In some examples the signal may be (i) a medical imaging signal, such as a sonography signal, or a magnetic resonance imaging (MRI) signal, or (ii) an audio signal produced by a patient other than by speaking (e.g., a signal produced by an electronic stethoscope). As another example, a signal being enhanced may be a test signal produced by a device under test at a testing stage of a manufacturing plant.

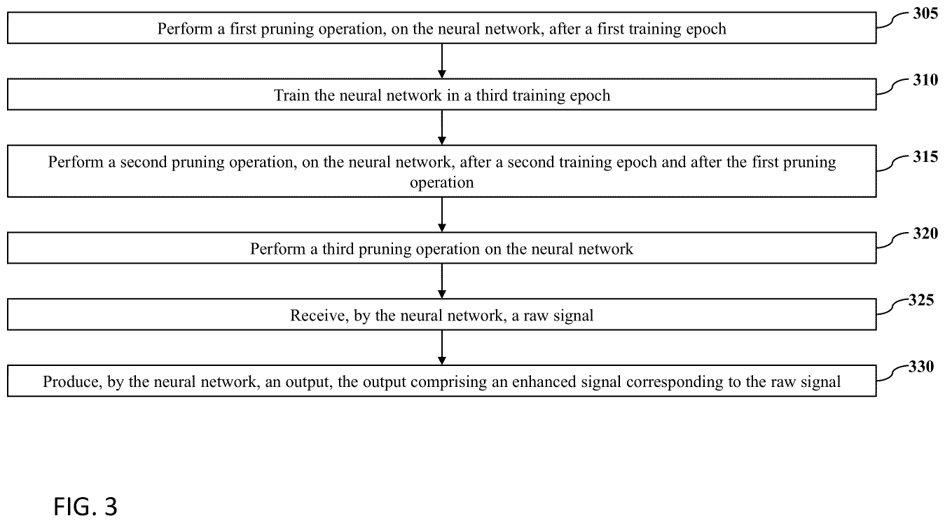

FIG. 3 is a flow chart of a method, in some embodiments. The method includes, performing, at 305, a first pruning operation, on the neural network, after a first training epoch; training, at 310, the neural network in a third training epoch; performing, at 315, a second pruning operation, on the neural network, after a second training epoch and after the first pruning operation; performing, at 320, a third pruning operation on the neural network; receiving, at 325, by the neural network, a raw signal; and producing, at 330, by the neural network, an output, the output comprising an enhanced signal corresponding to the raw signal.

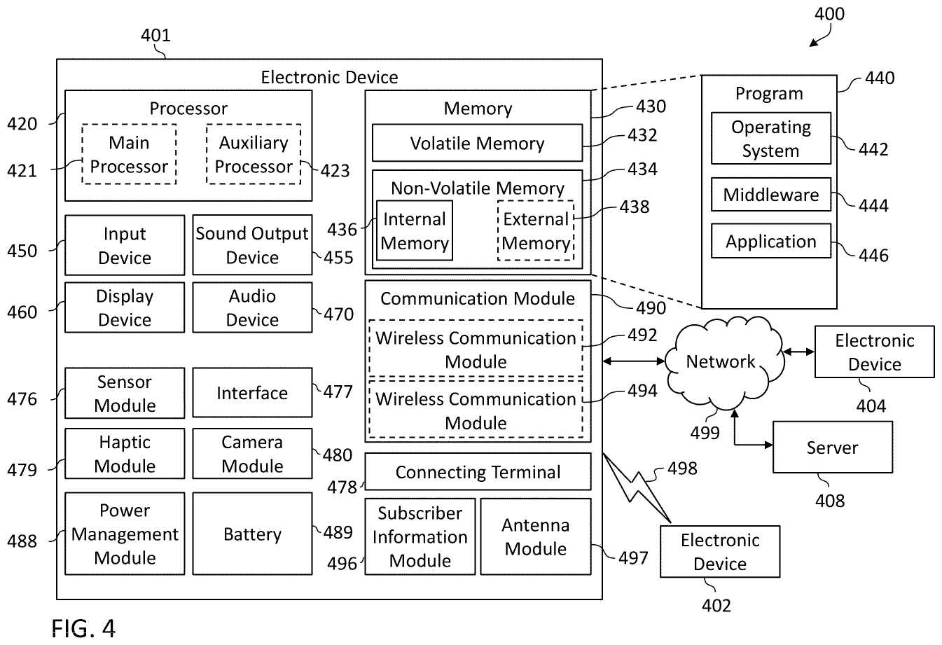

FIG. 4 is a block diagram of an electronic device in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

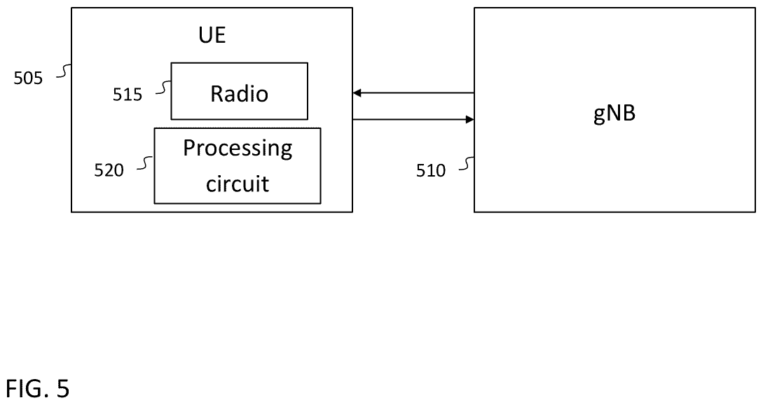

FIG. 5 shows a system including a UE 505 and a gNB 510, in communication with each other. The UE may include a radio 515 and a processing circuit (or a means for processing) 520, which may perform various methods disclosed herein, e.g., the method illustrated in FIG. 3. For example, the processing circuit 520 may receive, via the radio 515, transmissions from the network node (gNB) 510, and the processing circuit 520 may transmit, via the radio 515, signals to the gNB 510. Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
training a neural network, the training comprising:
performing a first pruning operation, on the neural network, after a first training epoch, and
performing a second pruning operation, on the neural network, after a second training epoch and after the first pruning operation,
wherein each of the pruning operations results in a respective pruning fraction, the respective pruning fraction being a function of an index of a training epoch preceding the pruning operation.

2. The method of claim 1, wherein an increase in a pruning fraction during the second pruning operation is less than an increase in the pruning fraction during the first pruning operation.

3. The method of claim 2, further comprising training the neural network in a third training epoch, after the first training epoch, and before the second training epoch.

4. The method of claim 1, further comprising performing a third pruning operation on the neural network after the second pruning operation,
wherein an increase in the respective pruning fraction during the third pruning operation is less than an increase in the respective pruning fraction during the second pruning operation.

5. The method of claim 1, wherein:
the training comprises performing a sequence of four or more pruning operations,
each of the pruning operations of the sequence increases a respective pruning fraction by an amount less than a preceding pruning operation of the sequence,
the sequence ends at a stopping epoch for pruning, and
the stopping epoch for pruning is a training epoch after which a final pruning operation of the sequence is performed.

6. The method of claim 5, wherein each of the pruning operations results in a respective pruning fraction, the respective pruning fraction being a function of:
an index of a training epoch,
a number of training epochs per pruning operation, and
an initial pruning fraction.

7. The method of claim 6, wherein the function has:
a value of zero when the index of the training epoch is less than the number of training epochs per pruning operation, and
a value of the initial pruning fraction, after the first pruning operation.

8. The method of claim 7, wherein:
for each training epoch less than or equal to the stopping epoch for pruning:
the function includes a second term subtracted from a first term,
the first term is one,
the second term is a first difference raised to the power of the floor of the ratio of the index of the training epoch and the number of training epochs per pruning operation, and
the first difference is one less the initial pruning fraction; and
for each training epoch greater than the stopping epoch, the function is equal to the respective pruning fraction after the last pruning operation.

9. The method of claim 1, wherein:
the neural network comprises a fully connected layer; and
the first pruning operation comprises removing a row or a column of the fully connected layer.

10. The method of claim 1, wherein:
the neural network comprises a multi-head self-attention block; and
the first pruning operation comprises removing a row or a column of the multi-head self-attention block.

11. The method of claim 1, wherein:
the neural network comprises a convolutional layer; and
the first pruning operation comprises removing a row or a column or a channel of a convolutional kernel of the convolutional layer.

12. The method of claim 1, wherein:
the neural network comprises a first conformer layer and a second conformer layer, and
the training comprises setting each of a plurality of weights of the second conformer layer equal to a respective weight of the first conformer layer.

13. The method of claim 1, wherein the training comprises knowledge distillation.

14. The method of claim 1, further comprising receiving, by the neural network, a raw signal, and producing, by the neural network, an output, the output comprising an enhanced signal corresponding to the raw signal.

15. A system comprising:
one or more processors; and
a memory storing instructions which, when executed by the one or more processors, cause performance of:
training a neural network, the training comprising:
performing a first pruning operation, on the neural network, after a first training epoch, and
performing a second pruning operation, on the neural network, after a second training epoch and after the first pruning operation,
wherein each of the pruning operations results in a respective pruning fraction, the respective pruning fraction being a function of an index of a training epoch preceding the pruning operation.

16. The system of claim 15, wherein:
the neural network comprises a fully connected layer; and
the first pruning operation comprises removing a row or a column of the fully connected layer.

17. The system of claim 15, wherein:
the neural network comprises a multi-head self-attention block; and
the first pruning operation comprises removing a row or a column of the multi-head self-attention block.

18. The system of claim 15, wherein:
the neural network comprises a convolutional layer; and
the first pruning operation comprises removing a row or a column or a channel of a convolutional kernel of the convolutional layer.

19. The system of claim 15, wherein:
the neural network comprises a first conformer layer and a second conformer layer, and
the training comprises setting each of a plurality of weights of the second conformer layer equal to a respective weight of the first conformer layer.

20. A system comprising:
means for processing; and
a memory storing instructions which, when executed by the means for processing, cause performance of:
training a neural network, the training comprising:
performing a first pruning operation, on the neural network, after a first training epoch, and
performing a second pruning operation, on the neural network, after a second training epoch and after the first pruning operation,
wherein each of the pruning operations results in a respective pruning fraction, the respective pruning fraction being a function of an index of a training epoch preceding the pruning operation.
